(19) United States
(12) Patent Application Publication
(10) Pub. No.: US 2021/0240006 A1
(43) Pub. Date: Aug. 5, 2021

(54) CUSTOMIZABLE EYEGLASSES

(71) Applicant: PERTA, LLC, Mission Viejo, CA (US)

(72) Inventor: Jonas Calleja Rojas, Westminster, CA (US)

(21) Appl. No.: 17/030,177

(22) Filed: Sep. 23, 2020

Related U.S. Application Data
(60) Provisional application No. 62/906,966, filed on Sep. 27, 2019.

(51) Int. Cl. G02C 5/04; G02C 5/22; G02C 5/20

(52) U.S. Cl. CPC G02C 5/045; G02C 5/20; G02C 5/22

(57) ABSTRACT

A set of customizable eyeglasses allows customers to make adjustments to a width of eyeglass frames relative to one another, a width of eyeglass temples relative to one another, a depth of eyeglass temples from the eyeglass frames, and/or a length of the nose bridge support from the customer's face. The customer could input one or more measurements into a system, such as a width and depth of a face, and a company could manufacture the eyeglass components in accordance with the measurements to provide rough adjustments to the eyeglasses to be sent to the customer. When the customer receives the eyeglasses, the customer could then make fine adjustments to the eyeglasses to further customize the fit.

### CROSS-REFERENCE TO RELATED APPLICATIONS

This application claims the benefit and priority of U.S. Application Ser. No. 62/906,966, filed on 2019, Sep. 27, the entire contents of which is expressly incorporated herein by reference.

### STATEMENT RE: FEDERALLY SPONSORED RESEARCH/DEVELOPMENT

Not Applicable

### BACKGROUND

The various aspects and embodiments described herein relate to eyeglass apparatus and customization thereof.

Every person is unique. While mass-produced eyeglasses fit most people just fine, many customers prefer customized eyeglasses that are shaped to fit their unique facial features. Custom-made eyeglasses are expensive and time-consuming to produce, however, and require a professional to measure a person's facial features, build a custom frame that matches the person's facial features, assemble eyeglasses with the custom frame, and then ship or otherwise deliver the custom eyeglasses to the customer. If any of the initial measurements are incorrect, the process needs to then be repeated with more accurate measurements.

Accordingly, there is a need in the art for ways to provide eyeglasses that are easily customizable.

### BRIEF SUMMARY

The various aspects and embodiments discussed herein relate to eyeglasses that have components that be set to have customizable distances from one another. By providing such eyeglasses to customers, the customers can make adjustments to a width of eyeglass frames relative to one another, a width of eyeglass temples relative to one another, and/or a depth of eyeglass temples from the eyeglass frames. The customer could input one or more measurements into a system, such as a width and depth of a face, and a company could manufacture the eyeglass components in accordance with the measurements to provide rough adjustments to the eyeglasses to be sent to the customer, for example via 3-D printing technology. When the customer receives the eyeglasses, the customer could then make fine adjustments to the lengths of various components of the eyeglasses to further customize the fit of the customized eyeglasses to the customer's face.

A set of customizable eyeglasses generally comprises two or more eyeglass frames that are connectable to one another via frame-bridge connectors. A bridge support locks the frame-bridge connectors in place relative to one another. Preferably, the bridge support locks the frame-bridge connectors in place along at least two different locations of a width axis. This way, the eyeglass frames could be customized to fit different people having different eye-widths.

In some embodiments, the eyeglass frames could be configured to be reversible, such that a given eyeglass frame could be used as a frame for a left eye or a right eye. This reduces the need for accuracy when ordering and placing reversible eyeglass lenses within the frames, since the frames could be switched between one eye and another as necessary. This also increases the variability of designs available to a customer, who could use an eyeglass frame for either eye, and who could position either side of the eyeglass frame as “forward.”

The set of customizable eyeglasses also generally comprises at least a two temple supports that are coupled to the eyeglass frames with temple-frame connectors. The eyeglass frames could be coupled to the temple supports via frame-temple connectors (different from the temple-frame connectors of the temple supports). Locking mechanisms could lock the temple supports in place relative to the eyeglass frames to fix the effective length of the temple supports when the eyeglasses are worn. In this way, the eyeglass frames could be customized to fit different people having different head-depths. Each locking mechanism is preferably hidden within a wall of the customizable eyeglasses, providing a blended, flush look when the locking mechanism is engaged.

In preferred embodiments, one or more temple corners could be used to lock the temple supports in place relative to the eyeglass frames. For example, a temple corner could lock a temple support in place along two or more locations of a depth axis. In preferred embodiments, the depth axis and the width axis are substantially orthogonal to one another (e.g. within 1, 2, 3, 4, 5, or 10 degrees of 90 degrees from one another. In some embodiments, the depth axis for one temple support could be offset slightly from the depth axis for another temple support, allowing for the temples to be non-parallel and angled from one another.

The temple supports could also allow adjustment of the distance of one or more of the temple supports relative to the eyeglass frames along the width axis. This way, the eyeglass frames could be customized to fit different people having different head-widths. Preferably, the temple supports could also be configured to be used on both a right-side of a person's head and a left-side of a person's head, adding to the configurability of the customizable eyeglasses.

Any suitable locking mechanism along a length of a component of the customizable eyeglasses could be used. For example, a connector, such as the frame-bridge connector, the temple-frame connector or the frame-temple connector, could comprise a series of recesses along a length, and the locking mechanism could comprise a projection that mates with a plurality of the recesses. In some embodiments, the connector and the locking mechanism could both comprise matching zig-zag surfaces that mate with one another when juxtaposed with one another. The locking mechanism could comprise a matching surface mounted on a hinge that swings between a locked position to an unlocked position, allowing the element of the customizable eyeglasses to move along an axis when disposed in the unlocked position, and locking the element in place along the axis when disposed in the locked position. While the connectors preferably have projections and/or recesses that are regularly spaced from one another, the connectors could have projections and/or recesses that are irregularly spaced in other embodiments. In embodiments where the projections and/or recesses are regularly spaced from one another, one connector could have projections and/or recesses that are spaced closer or further than the projections and/or recesses of another connector. This allows for differing fine-adjustments for different connections between components of the customizable eyeglasses.

In some embodiments, the customizable eyeglasses could be ordered by a customer remotely, such as through the phone or via an online interface. A customer could dictate a series of measurements, such as an eye width, a head width, a head depth, and/or a nose depth. A manufacturer could then select eyeglass components having appropriate lengths based upon the measurements, or could custom-make the eyeglass components having appropriate lengths based upon the measurements provided. In some embodiments, the customer could also select other custom aspects of the eyeglasses, such as the type of ear mount, or a color of any one or more of the components, or even a level of adjustment (e.g. fine adjustment of 0.1 in spacings for the bridge and the temple depth and rough adjustment of 0.3 in. spacings for the temple width). The components could then be sent to the customer with lengths that are sized appropriately for the customer. The customer could then assemble the eyeglasses, and adjust the locking mechanisms to make fine-adjustments to the various lengths to ensure that the eyeglasses fit appropriately on the customers' face and head.

In preferred embodiments, each of the components are fungible with other like components. For example, a left-side eyeglass frame of one shape could be switched out for a left-side eyeglass frame of another shape, a left temple support and a right temple support could be switched with one another, or a left-side eyeglass frame could be switched with a right-side eyeglass frame. This allows the size, shape, and style of the eyeglass frames to change dynamically with the wishes of the customer. This also allows a customer to add a preference of one design on one side and another design on another side (e.g. a white paint on one side of an eyeglass frame and a striped black and yellow paint on another side of the eyeglass frame), allowing for many different, dynamic looks.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1A is a front perspective view of an exemplary eyeglass frame.

FIG. 1B is a side view of the eyeglass frame of FIG. 1A.

FIG. 2A is a front perspective view of a support having a locking mechanism.

FIG. 2B is a side view of the bridge support of FIG. 2A.

FIG. 3A is a front perspective view of an alternative bridge support having two locking mechanisms.

FIG. 3B is a side view of the bridge support of FIG. 3A.

FIG. 4 is a front perspective view of the eyeglass frame of FIG. 1 and an alternative eyeglass frame.

FIG. 5 is a front perspective view of the two eyeglass frames of FIG. 4 coupled together using the bridge support of FIG. 3.

FIG. 6 is a front perspective view of the two eyeglass frames of FIG. 4 coupled together using the bridge support of FIG. 3 in an alternative configuration.

FIGS. 7A and 7B shows front perspective views of two exemplary temple corners.

FIG. 8 shows a front perspective view of the eyeglass frames of FIG. 5 coupled with the temple corners of FIGS. 7A and 7B.

FIGS. 9A and 9B shows front perspective views of two exemplary temple frames.

FIG. 10 shows a front perspective view of the temple frames of FIGS. 9A and 9B coupled with the eyeglass frames and temple corners of FIG. 9.

### DETAILED DESCRIPTION

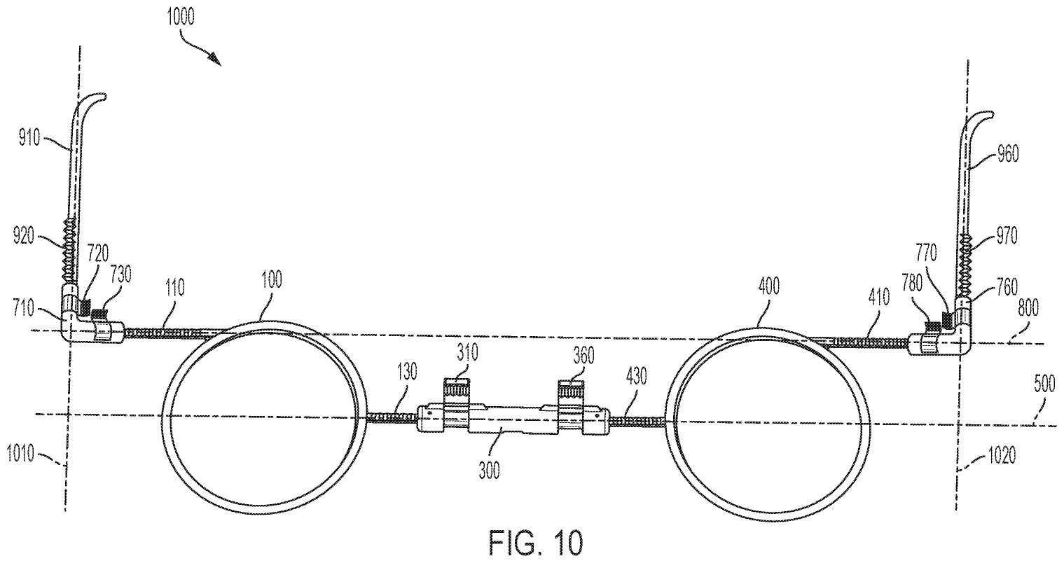

Referring now to the drawings, in particular FIG. 10, customizable eyeglasses 1000 have a first eyeglass frame 100, a second eyeglass frame 400 and a bridge connector 300 that locks the position of the first eyeglass frame 100 and the second eyeglass frame 400 relative to one another along width axis 500. Bridge connector 300 could be moved along width axis 500 down the length of frame-bridge connector 130 and could be locked in place by closing door 310, while bridge connector 300 could be moved along width axis 500 down the length of frame-bridge connector 430 to be locked in place by closing door 360. This allows a customer to adjust the width of first eyeglass frame 100 and second eyeglass frame 400 relative to one another to fit a specific eye width distance. This also allows a customer to adjust the distance of first eyeglass frame 100 from bridge connector 300 independently from second eyeglass frame 400, while centering bridge connector 300 to the customer's nose even if the customer's eyes are not asymmetrically spaced about the nose.

First eyeglass frame 100 and second eyeglass frame 400 are also coupled to first temple corner 710 and to second temple corner 760, respectively. First temple corner 710 could be moved along width axis 800 following a length of frame-temple connector 110 and could be locked in place by closing door 730, while second temple corner 760 could be moved along width axis 800 following a length of frame-temple connector 410 and could be locked in place by closing door 780. This allows a customer to adjust the width of first temple corner 710 and second temple corner 760 relative to one another to fit a specific head width distance. This also allows a customer with asymmetrical widths between their eye and the side of the head to perform independent fine-adjustments for either side independently from one another of the custom eyeglasses 1000.

First temple support 910 and second temple support 960 are also coupled to first temple corner 710 and to second temple corner 760, respectively. First temple corner 710 could be moved up and down depth axis 1010 along a length of temple-frame connector 920 and could be locked in place by closing door 720. Second temple corner 720 could be moved along depth axis 1020 along a length of temple-frame connector 970 and could be locked in place by closing door 770. This allows a customer to adjust the depth of the first temple support 910 and second temple support 960 to fit a specific head depth distance. This also allows a customer with asymmetrical depths between the front side of his right eye and ear and between the front side of his left eye and ear to perform independent fine-adjustments for either temple support independently.

Each door, such as door 310 and 360 of bridge connector 300 or door 720 and 730 of temple corner 710, is preferably configured to close such that the surface of the door is flush with a major surface to provide a blended, flush look when the doors are closed. This hides the lock from a cursory inspection, preventing the lock from disturbing a continuous look of customizable eyeglasses 1000.

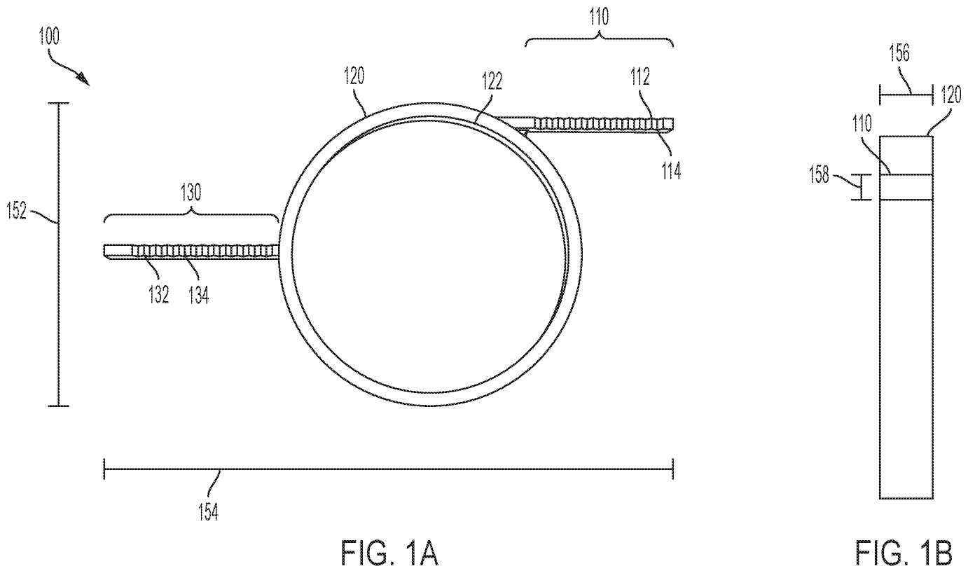

As shown in FIGS. 1A and 1B, an eyeglass frame 100 has a frame-temple connector 110, a lens holder 120, and a frame-bridge connector 130. Lens holder 120 comprises a frame configured to hold a lens via any suitable means, for example via recess 122. Lens holder 120 comprises a semi-elastic material, such as plastic, that can flex slightly to allow a lens to be placed within recess 122 when a force is applied to opposing sides of lens holder 120, but returns back to its original shape when the force is removed. While lens holder 120 is shown as a flexing lens holder having a recess, lens holder 120 could be configured to hold a lens in any suitable manner, for example via a set of clasps or a set of threaded vice-grips. While lens holder 120 is shown as a circular lens, lens holder 120 could be shaped in any suitable manner, for example a rectangular, oval, triangular, or hexagonal shape.

Frame-temple connector 110 comprises a length of material that is used to couple eyeglass frame 100 to a temple support (not shown). Frame-temple connector 110 has a series of projections 112 and a series of recesses 114 which are used to mate with a locking mechanism (not shown) that will hold frame-temple connector 110 in place a set distance away from a temple support. While frame-temple connector 110 is shown as a length of material having a zig-zag surface that is sized to mate with a similarly-shaped zig-zag surface, frame-temple connector 110 could be sized in any suitable manner to allow a locking mechanism to fixedly couple with a plurality of locations along a length of frame-temple connector 110, such as a rectangular bar with square holes, a circular bar with triangular holes, a length of material having recesses along a perimeter of regularly spaced cross-sectional areas, a cylindrical bar having a thread wrapped around a length of the bar, or an length of material with hooks and/or loops. While frame-temple connector 110 is shown as coupled to a top side of lens holder 120, frame-temple connector 110 could be disposed at any height along a side of lens holder 120.

Frame-bridge connector 130 is shaped similarly to frame-temple connector 130, but is configured to couple to a bridge support (not shown). Frame-bridge connector 130 also has a series of projections 132 and a series of recesses 134 which are used to mate with a locking mechanism (not shown) that will hold frame-bridge connector 130 in place a set distance away from the bridge support. Again, other frame-bridge connectors could be used that allow a locking mechanism to fixedly couple to a plurality of locations along the length of frame-bridge connector. While frame-bridge connector 130 is shown as coupled to a middle position of lens holder 120, frame-bridge connector 130 could be disposed at any height along a side of lens holder 120.

While the connectors shown herein are disclosed as having projections and recesses that are regularly spaced, the connectors could be irregularly spaced, or could be regularly spaced in proportions that are different from other connectors. For example, frame-temple connector 110 could have projections and/or recesses that are spaced further apart from one another than frame-bridge connector 130 (e.g. spaced 0.3 in apart for frame-temple connector 110 vs. 0.1 in for frame-bridge connector 130). The projections and/or recesses of a connector could have spacings that are less than 0.05, 0.1, 0.2, 0.3. 0.4, and 0.5 in apart.

Frame 100 is shown as comprising a single contiguous material, such as a plastic that has been 3-D printed or molded within a mold, but could comprise a plurality of discrete parts that are assembled to form frame 100. Frame 100 preferably comprises a material, or materials, that are at least rigid or semi-rigid, having a Young's modulus of at least 2, 3, 4, 5, or 10 GPa.

Frame 100 is shown having a height 152, a length 154, and a depth 156. The dimensions of frame 100 could be any suitable dimension to be used for a set of eyeglasses. For example, height 152 could be at most 3 in, at most 2 in, at most 1 in, or at least 0.5 in. Length 154 could be at most 5 in, 4 in, 3 in, or at least 2 in. Depth 156 could be at most 0.5 in, 0.25 in, 0.125 in, or at least 0.1 in.

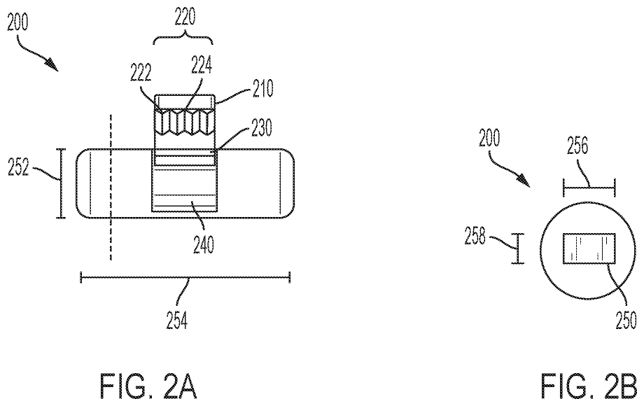

As shown in FIGS. 2A and 2B, a support 200 could comprise a cylindrical body with a cavity 250 that accepts a connector, such as frame-temple connector 110 or frame-bridge connector 130, which is locked in place when door 210 is closed. Cavity 250 preferably runs through the center of the cylindrical body of support 200, Door 210 comprises a lock 220 having a plurality of projections 222 and recesses 224 that mate with a connector inserted into cavity 250. Door 210 is coupled to the main body of support 200 via hinge 230, which rotates door 210 from an open position to a closed position to cover cavity 240. Door 210 is preferably configured to have a shape that matches an exterior shape of support 200 to provide for a blended, flush look when door 210 is closed. Here, door 210 actives this shape by being cut out from the cylindrical support 200 with a living hinge 230 of thin material left between door 210 and the main body of support 200. However, other suitable means of creating a flush look when door 210 is closed could be used in other embodiments.

While lock 220 is shaped to substantially mate with each of connectors frame-temple connector 110 and frame-bridge 130 (e.g. projections 222 mate with recesses 114 and projections 112 mate with recesses 224), lock 220 could be shaped in a non-similar manner, for example by leaving spaces and gaps in between surfaces of lock 220 and surfaces of frame-temple connector 110, while still being configured to have projections that engage one or more recesses of frame-temple connector 110 (or vice-versa, by having projections of frame-temple connector 110 that engage one or more recesses of lock 220). Support 200 could be made from any suitable material, but is preferably made from the same material as frame 100 to encourage a consistent look/feel between portions of the customized eyeglasses.

Support 200 is shown having a height 252 equal to its depth, and a length 254, but could be sized and shaped to any suitable dimension that allows for support 200 to be configured to lock in place relative to a connector that is inserted into cavity 250. Here, the height 252 is configured to be 0.25 in and the length 254 is configured to be 1 in., however, any suitable height and length could be used to couple with a connector. Cavity 250 is shown having a height 258 and a length 256 sized to match the height and length of a connector configured to mate with support 200, for example frame-temple connector 110, and preferably has substantially the same dimensions, only slightly larger (e.g. having within 5%, 4%, 3%, 2%, or 1% of the same cross-sectional area), to allow for the connector to be easily inserted into cavity 250.

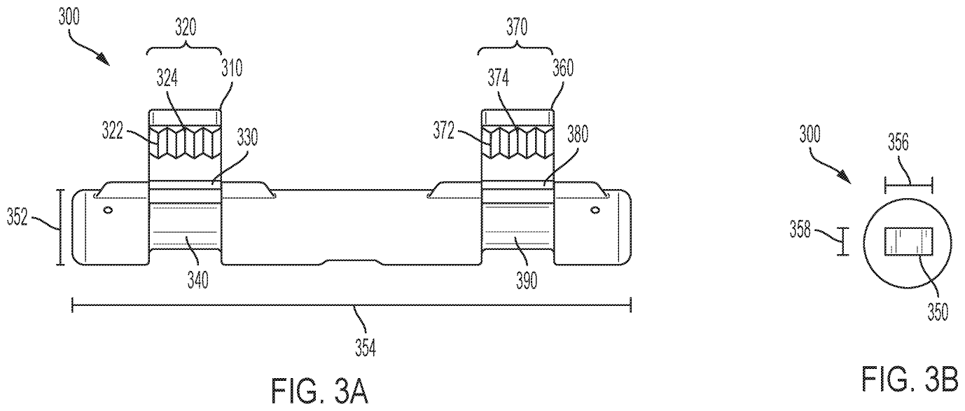

As shown in FIGS. 3A and 3B, a bridge support 300 could also comprise a cylindrical body with a cavity 350 and doors 310 and 370. Bridge support 300 has two doors 310 and 370 for two separate locks, one for each of two connectors that couple with bridge support 300. Much like support 200, Bridge support 300's door 310 has a lock 320 comprising projections 322 and recesses 324, where door 310 is coupled to the main body of bridge support 300 via a hinge 330 that could be used to move door 310 from an open, unlocked position to a closed, locked position that covers cavity 340. Bridge support 300's door 360 has a lock 370 comprising projections 372 and recesses 374, where door 360 is coupled to the main body of bridge support 300 via a hinge 380 that could be used to move door 360 from an open, unlocked position to a closed, locked position that covers cavity 390. Door 310 and 360 are preferably configured to have a blended, flush look when the doors are closed, for example by having a surface that is flush with the major surface of bridge support 300.

Bridge support 300 is shown having a height 352 equal to its depth, and a length 354, but could be sized and shaped to any suitable dimension that allows for bridge support 300 to be configured to lock in place relative to connectors that are inserted into cavity 350. Here, the height 352 is configured to be 0.25 in and the length 354 is configured to be 2 in., however, any suitable height and length could be used to couple with a connector. Cavity 350 is shown having a height 358 and a length 356 sized to match the height and length of a connector configured to mate with support 300, for example frame-bridge connector 130, and preferably has substantially the same dimensions, only slightly larger (e.g. having within 5%, 4%, 3%, 2%, or 1% of the same cross-sectional area), to allow for the connector to be easily inserted into cavity 350.

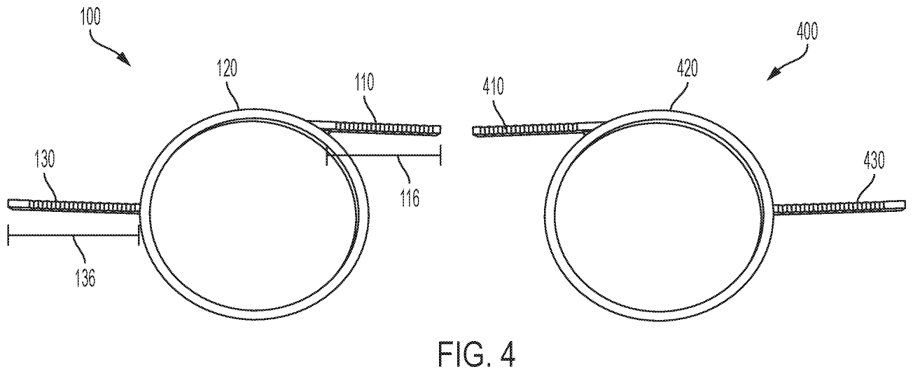

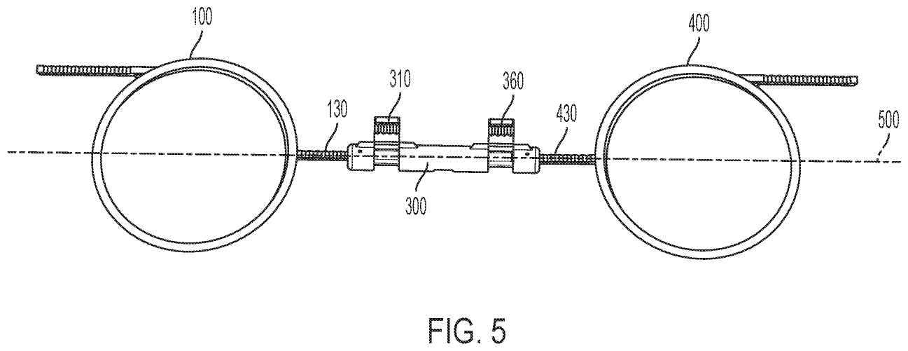

FIGS. 4 and 5 show an exemplary set of eyeglass frames 100 and 400 that could be coupled together using bridge support 300. Eyeglass frame 400 is shown to be a mirror image of eyeglass frame 100, having frame-temple connector 410, lens holder 420, and frame-bridge connector 430. Frame-bridge connector 130 could be inserted into one side of cavity 350 while frame-bridge connector 430 could be inserted into the other side of cavity 350. Bridge support 300 could then be moved along width axis 500 along either of frame-bridge connector 130 and frame-bridge connector 430 until the frames are set to the correct eye-width for a user.

Frame-bridge connector 130 is shown as having length 136 while frame-temple connector 116 is shown as having a length 116. The connectors could have any suitable length, for example a length of at most 3 inches, 2.5 inches, 2 inches, 1 inches, or at least 0.25 inches long. In some embodiments, the length of the connector could be custom-manufactured as a function of a length provided by a customer. For example, a customer could disclose that her eyes are about 1.5 inches apart, so the frame-bridge connectors are built to each have a length of 50% of the input length, which is 0.75 inches. Any suitable algorithm could be used, for example an algorithm to make the connectors 20%, 30%, 40%, or even 70% of a measurement provided by a customer. In other embodiments, a customer could be provided a cutting tool that shortens a length of a connector. For example, a customer could be provided an eyeglass frame having a frame-bridge connector having a length of 1.5 inches, and the customer could then choose to cut the length of the connector down to 0.6 inches to be suitable for the customer to then make fine-adjustments to the eyeglasses.

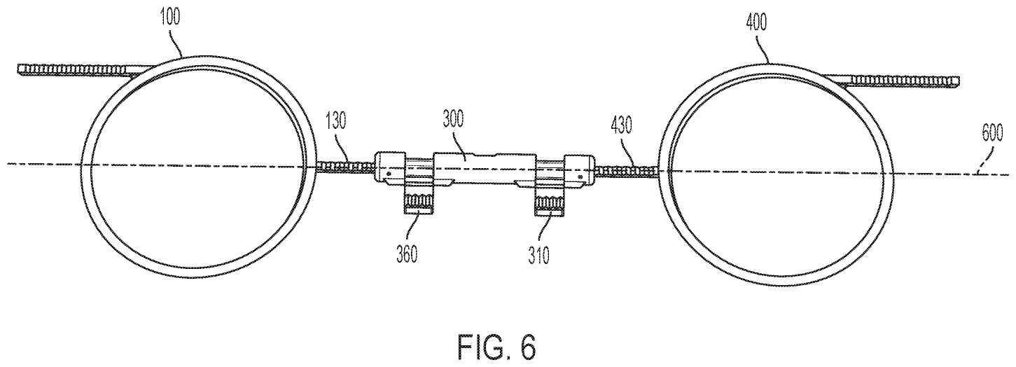

As shown in FIGS. 5 and 6, eyeglass frames 100 and 400 are configured to be switched with one another by flipping each frame and inserting the bridge-frame connectors 130 and 430 into opposing sides of bridge support 300. By providing eyeglass frames that can be easily switched and flipped in the provided configurations, a customer could easily move a frame from a right-eye configuration to a left-eye configuration and vice-versa, and could also change a coloring of the frame, in embodiments where the eyeglass frame has one color on one side and another color on another side. While only two eyeglass frames are shown, a plurality of fungible eyeglass frames could be provided having similarly shaped frame-bridge connectors so as to improve the ability of the customer to vary the style and configuration of eyeglasses that could be configured using the disclosed bridge support.

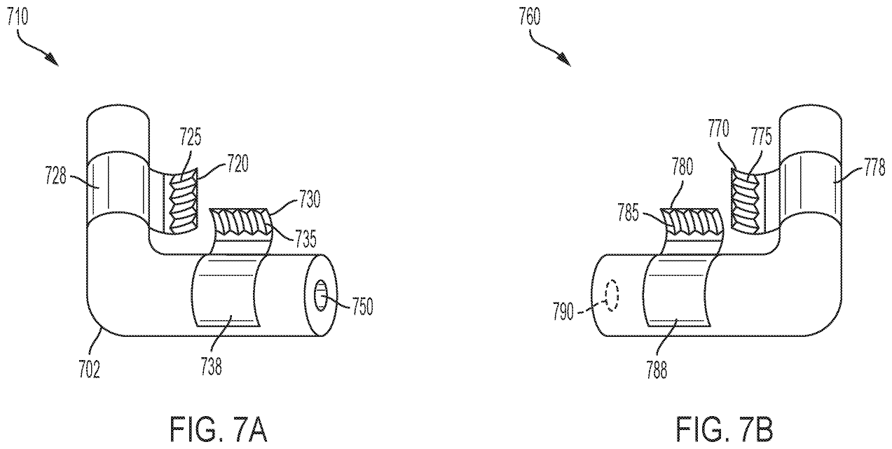

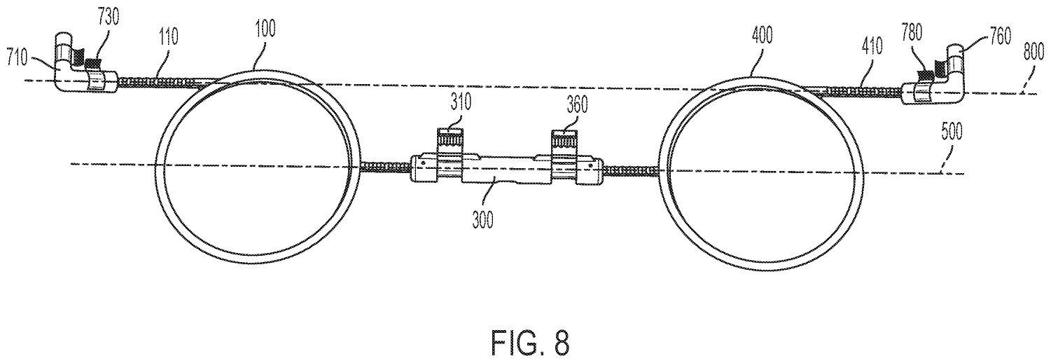

FIGS. 7A and 7B show temple corners 710 and 760, which could be provided to help couple eyeglass frames to temple supports. Temple corner 710 is similar to bridge support 300 in that temple corner 710 has two doors, door 720 with lock 725 and door 730 with lock 735, which both act as locks to connectors inserted into cavity 750. The doors are preferably configured to have a blended, flush look when the doors are closed, for example by having a surface that is flush with the major surface of the main body of the temple corners. Bend 710 is shown here as a substantially orthogonal bend, but could comprise any suitable angle in other embodiments. For example, bend 710 could form an acute or an obtuse angle to cavity 750. In some embodiments, bend 710 comprises a hinge that could be rotated to a plurality of angles, and could be locked to one or more preferred angles by a customer. Temple corner 760 is shown here as a mirror-image of temple corner 710, having door 770 with lock 775, door 780 with lock 885, and cavity 790 that travels through the bent length of temple corner 760.

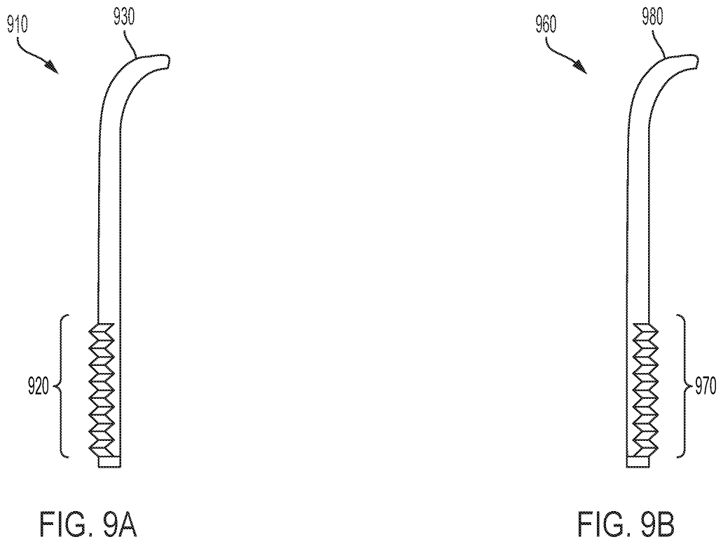

In FIG. 9, frames 100 and 400 are coupled to temple corners 710 and 760, respectively. Frame-temple connector 110 is inserted into cavity 750 of temple corner 710 and is adjusted similarly to bridge support 300. A customer could then move frame-temple connector 110 down a length of axis 800 and could close door 730 to temple corner 710 in place relative to eyeglass frame 100. In some embodiments, the length of frame-temple connector 110 is manufactured as a function of a measurement provided by a customer (e.g. 10%, 20%, or 30% of a head width measurement provided by a customer, or the head width measurement minus a width of both lens frames and the eye width measurement provided by the customer), while in other embodiments the customer is provided with a cutting tool or other instructions that the customer could use to cut off an extra length of frame-temple connector 110. Frame-temple connector 410 is similarly coupled to cavity 790 of temple corner 760. In this manner, a customer could custom-mount each of temple corners 710 and 760 to each of frame-temple connector 110 and frame-temple connector 410 to fit a width of the customer's head using fine adjustments.

FIGS. 9A and 9B show temple supports 910 and 960, respectively, which are both used to support customized eyeglasses fitted to a customer's temple. Temple support 910 comprises a temple-frame connector 920 and an ear support 930, while temple support 960 comprises a temple-frame connector 970 and an ear support 980. Temple-frame connector 920 and temple-frame connector 970 are shown here as sized and shaped similarly to other connectors of the eyeglasses 1000, such as frame-bridge connector 130 and frame-temple connector 110, but could be shaped differently to match a different type of locking mechanism.

FIG. 10 shows a completed set of eyeglasses, where temple support 910 is coupled to temple corner 710 and temple support 960 is coupled to temple corner 760. Temple-frame connector 920 is inserted into cavity 750, and is moved along axis 1010 until an appropriate depth is reached. Similar to the connectors above, a length of temple-frame connector 920 and temple-frame connector 970 is preferably manufactured as a function of a measurement provided by a customer (e.g. 10%, 20%, 30%, or 40% of a head depth measurement provided by a customer, or the head depth measurement minus a standardized length of an ear support, such as ear support 910). In alternative embodiments, the customer could shorten a length of temple-frame connector 920 by using a cutting tool. The customer could then lock temple support 910 relative to temple corner 710 by closing door 720. Likewise, the customer could lock temple support 960 relative to temple corner 760 by closing door 770. By allowing a customer to fine-tune where, exactly, temple corner 710 locks to temple support 910 and where temple corner 760 locks to temple support 970, the manufacturer of custom eyeglasses 1000 allows the customer to fine-tune the depth of custom eyeglasses 1000 to match a desired depth.

While depth axis 1010 and depth axis 1020 are shown here as substantially orthogonal to width axis 500 and width axis 800, and are shown here as substantially parallel to one another, depth axis 1010 and 1020 could be non-parallel to one another in some embodiments, depending upon the configuration of the temple corners used for customized eyeglasses 1000.

Similar to eyeglass frames 100 and 400, temple supports 910 and 960 could be configured to be fungible with one another, and could be configured to mate with opposing temple corners. In such embodiments, doors 720 and 770 are configured to be removable from their hinges and be coupled to opposing sides of cavities 728 and 778, respectively, to rotate in the opposite direction. In other embodiments, other locking mechanisms could be used, such as threaded tighteners or clamps, which would eliminate the need for detachable and reattachable hinged connections. While only two temple supports are shown, more temple supports could be provided to a customer, allowing a customer to fully interchange temple supports with one another to create different designs, looks, and styles.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A set of customizable eyeglasses, comprising:
a first-side eyeglass frame having a first frame-bridge connector and a first frame-temple connector;
a second-side eyeglass frame having a second frame-bridge connector and a second frame-temple connector;
a first temple support having a first temple-frame connector;
a second temple support having a second temple-frame connector;
a bridge support that locks the first frame-bridge connector in place relative to the second frame-bridge connector in at least two different locations along a width axis;
a first temple corner that locks the first frame-temple connector in place relative to the first temple-frame connector in at least two different locations along a first depth axis; and
a second temple corner that locks the second frame-temple connector in place relative to the second temple-frame connector in at least two different locations along a second depth axis.

2. The set of customizable eyeglasses of claim 1, wherein the width axis is substantially orthogonal to the depth axis.

3. The set of customizable eyeglasses of claim 1,
wherein the first frame-bridge connector comprises a set of recesses, and
wherein the first bridge support comprises a projection configured to mate with each of the set of recesses to lock the first bridge support in place relative to the first frame-bridge connector.

4. The set of customizable eyeglasses of claim 3, wherein the first bridge support comprises a hinge that rotates the projection between a locked position that locks the first bridge support in place relative to the first frame-bridge connector and an unlocked position that allows the first bridge support to move relative to the first frame-bridge connector.

5. The set of customizable eyeglasses of claim 1, wherein the first frame-bridge connector comprises a first set of teeth and the first bridge support comprises a locking mechanism comprising a second set of teeth configured to mate with the first set of teeth.

6. The set of customizable eyeglasses of claim 1, wherein the first-side eyeglass frame is configured to be used as a right-side eyeglass frame and a left-side eyeglass frame.

7. The set of customizable eyeglasses of claim 6, wherein the first temple support is configured to be used as a right-side temple support and a left-side temple support.

8. The set of customizable eyeglasses of claim 1, wherein the bridge support comprises nose-pads and a pad-bridge connector, and wherein the bridge support locks the pad-bridge connector in place relative to the bridge support.

9. The set of customizable eyeglasses of claim 1,
wherein the first temple corner locks the first frame-temple connector in place relative to the first temple-frame connector in at least two different locations along the width axis, and
wherein the second temple corner locks the second frame-temple connector in place relative to the second temple-frame connector in at least two different locations along the width axis.

10. A method of providing a set of customizable eyeglasses, comprising:
receiving a head width measurement from a customer;
manufacturing a first-side eyeglass frame having a first frame-bridge connector;
manufacturing a second-side eyeglass frame having a second frame-bridge connector;
manufacturing a bridge support that locks the first-frame bridge connector in place relative to the second frame-bridge connector in at least two different locations along a width axis;
selecting at least one of the first-side eyeglass frame, second-side eyeglass frame, and bridge support as a function of the head width measurement; and
providing the first-side eyeglass frame, second-side eyeglass frame, and bridge support to the customer.

11. The method of claim 10, wherein a length of the first frame-bridge connector and a length of the second frame-bridge connector is manufactured as a function of the head width measurement.

12. The method of claim 11, wherein the first-side eyeglass frame and the second-side eyeglass fame are 3-D printed as a function of the head width measurement.

13. The method of claim 10, further comprising:
receiving a head depth measurement from the customer;
manufacturing a first temple support having a first temple-frame connector;
manufacturing a second temple support having a second temple-frame connector,
wherein the first-side eyeglass frame comprises a first frame-temple connector, and
wherein the second-side eyeglass frame comprises a second frame-temple connector;
manufacturing a first temple corner that locks the first frame-temple connector in place relative to the first temple-frame connector in at least two different locations along a first depth axis; and
manufacturing a second temple corner that locks the second frame-temple connector in place relative to the second temple-frame connector in at least two different locations along a second depth axis;
selecting at least one of the first temple support and the second temple support as a function of the head depth measurement; and
providing the first temple support, second temple support, first temple corner, and the second temple corner as a function of the head depth measurement.

14. The method of claim 13, wherein a length of the first first temple-frame connector and a length of the second temple-frame connector is manufactured as a function of the head depth measurement.

15. The method of claim 10, further comprising:
receiving a color selection from the customer; and
painting at least one of the first-side eyeglass frame, second-side eyeglass frame, and bridge support as a function of the color selection.
